(19) United States
(12) Patent Application Publication
(10) Pub. No.: US 2004/0257660 A1
(43) Pub. Date: Dec. 23, 2004

(54) Method of manufacturing micro lens, micro lens, optical device, optical transmission device, head for laser printer, and laser printer

(75) Inventor: Hironori Hasei, Okaya-city (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/834,987

(22) Filed: Apr. 30, 2004

(30) Foreign Application Priority Data
May 16, 2003 (JP) 2003-138799

(51) Int. Cl. G01N 21/86; G02B 27/10

(52) U.S. Cl. 359/619

(57) ABSTRACT

To provide a method of manufacturing a micro lens, a micro lens, an optical device having the micro lens, an optical transmission device, a head for a laser printer, and a laser printer, in which excellent lens characteristics, such as a condensing function, can be obtained by optionally controlling the shape thereof as well as the non-uniformity thereof can be suppressed, a micro lens is formed on the upper surface of a foundation member formed on a base. The upper surface of the foundation member is subjected to lyophobic processing. The micro lens is formed by ejecting lens material in a plurality of dots on the upper surface of the lyophobic-processed foundation member from at least two nozzles by a droplet ejecting head having a plurality of nozzles.

### BACKGROUND OF THE INVENTION

1. Field of Invention

The present invention relates to a method of manufacturing a micro lens, a micro lens obtained by the method, an optical device having the micro lens, an optical transmission device, a head for a laser printer, and a laser printer.

2. Description of Related Art

Recently, optical devices having a plurality of minute lenses referred to as micro lenses have been provided. As these optical devices, there are, for example, light-emitting devices having lasers, optical interconnections formed of optical fibers, and solid-state image sensing devices having a condensing lens to collect incident light.

The micro lenses constituting such optical devices have been manufactured by a molding method using a mold or a photolithography method. See Japanese Unexamined Patent Application Publication No. 2000-35504.

In addition, recently, a method of forming micro lenses having a minute pattern using the droplet ejecting method used in printers has been suggested. See Japanese Unexamined Patent Application Publication No. 2000-280367.

### SUMMARY OF THE INVENTION

However, in the molding method using the mold or the photolithography method, since the mold or a complicated manufacturing process is needed in order to form the micro lens, there are problems in that the costs become high. Also, it is difficult to form a micro lens having a predetermined shape at a certain location.

In the case of employing the droplet ejecting method, it is easy to form the micro lens at a certain location. But it is difficult to control the shape thereof to a desired shape. Further, the droplet ejecting head has a plurality of nozzles. But a minute non-uniformity of the ejected amount between the nozzles is generated from, for example, the some variance of the structure. Thus the uniformity of the shape of the obtained micro lens is damaged due to the non-uniformity of the ejected amount. Accordingly, non-uniformity of the optical characteristics may be generated.

The present invention has been made in order to address the above-mentioned problems. The present invention provides a method of manufacturing a micro lens, a micro lens, an optical device having the micro lens, an optical transmission device, a head for a laser printer, and a laser printer, in which excellent optical characteristics, such as a condensing function, can be obtained by optionally controlling the shape of the micro lens. Also the non-uniformity can be suppressed.

In order to accomplish the above, a method of manufacturing a micro lens according to an aspect of the present invention includes forming a foundation member on a base; subjecting the upper surface of the foundation member to lyophobic processing; and ejecting lens material on the lyophobic-processed foundation member in a plurality of dots using at least two nozzles by a droplet ejecting head having a plurality of nozzles to form the micro lens on the foundation member.

According to the method of manufacturing the micro lens, since the micro lens is formed on the foundation member, the size or the shape of the upper surface of the foundation member is suitably controlled. As a result, the size or the shape of the obtained micro lens can be suitably controlled. In addition, since the upper surface of the foundation member is subjected to the lyophobic processing, the contact angle of the ejected lens material with respect to the upper surface of the foundation member can become large. Thus the amount of the lens material applied to the upper surface of the foundation member can become high. Since the lens material is ejected in a plurality of the dots under the state that the amount of the lens material applied to the upper surface of the foundation member is increased, the size or the shape of the obtained micro lens is favorably controlled by suitably adjusting the number of the dots. Thus the micro lens having a shape close to, for example, a sphere can be formed.

Since the material is ejected in a plurality of dots using at least two nozzles by the droplet ejecting head having a plurality of the nozzles, even when there is variance of the ejected amount between the nozzles, the influence of the variance of the ejected amount between the nozzles can be reduced by forming one micro lens using two or more nozzles. Accordingly, the non-uniformity of the shape of the obtained micro lens is suppressed, thereby reducing or preventing the variance of the optical characteristics.

In the method of manufacturing the micro lens, in the lyophobic process, when the lens material is positioned with respect to the plane formed of the foundation member forming material, the lyophobic process may be performed so that lyophobic properties that the contact angle of the lens material is 20° or more, are exhibited.

According to the configuration, since the contact angle of the ejected lens material with respect to the upper surface of the foundation member becomes large, the amount of the lens material applied to the upper surface of the foundation member can be increased.

In the method of manufacturing the micro lens, in forming the foundation member, the shape of the upper surface of the foundation member may be circular, elliptical, or polygonal.

According to the configuration, the micro lens having a shape close to a sphere can be formed. Thus the optical characteristics, such as a condensing function, can be controlled by suitably adjusting the curvature.

Moreover, in the method of manufacturing the micro lens, when ejecting the lens material by the droplet ejecting method, the number of the ejected dots may be determined so that the curvature of the upper surface of the formed micro lens becomes a predetermined curvature.

According to the configuration, since the curvature of the surface side becomes a predetermined curvature, the micro lens having desired optical characteristics can be formed by allowing the light from the upper surface to be transmitted.

In the method of manufacturing the micro lens, the lens material is composed of a non-solvent-type light-transmitting resin.

According to the configuration, since the size or shape of the obtained micro lens may be prescribed in accordance with the number of the dots of the ejected lens material, the desired size or shape of the obtained micro lens can be precisely formed by suitably adjusting the number of the ejected dots.

The micro lens according to an aspect of the present invention is characterized in that the micro lens is formed on the upper surface of a foundation member formed on a base, the upper surface of the foundation member is subjected to lyophobic processing. The micro lens is formed by ejecting lens material in a plurality of dots on the lyophobic-processed foundation member from at least two nozzles by a droplet ejecting head having a plurality of nozzles.

According to the micro lens, since the micro lens is formed on the foundation member, the size or the shape thereof can be favorably controlled by suitably controlling the size or the shape of the surface of the foundation member. In addition, since the surface of the foundation member is subjected to the lyophobic processing, the contact angle of the ejected lens material with respect to the upper surface of the foundation member becomes large. Thus the amount of the lens material applied to the upper surface of the foundation member can be increased. The size or the shape of the obtained micro lens is favorably controlled by suitably adjusting the number of the dots of the ejected lens material. Thus the micro lens having a shape close to, for example, a sphere can be formed.

Since the material is ejected in a plurality of dots using at least two nozzles by the droplet ejecting head having a plurality of the nozzles to form the micro lens, even when there is variance of the ejected amount between the nozzles, the influence of the variance of the ejected amount between the nozzles can be reduced by forming one micro lens using at least two nozzles. Accordingly, the non-uniformity of the shape of the obtained micro lens is suppressed, thereby reducing or preventing the variance of the optical characteristics.

In the micro lens, the shape of the upper surface of the foundation member may be circular, elliptical, or polygonal.

According to the configuration, the shape thereof becomes close to the sphere. Thus the optical characteristics, such as a condensing function, can be favorably controlled by suitably adjusting the curvature.

In the micro lens, the maximum outer diameter of the transverse section of the micro lens parallel to the upper surface of the foundation member may be larger than the outer diameter of the upper surface of the foundation member.

According to the configuration, since the micro lens has the outer diameter of the transverse section larger than the outer diameter of the upper surface of the foundation member, the micro lens has, for example, a shape close to the sphere. Thus the optical characteristics, such as a condensing function, can be favorably controlled by suitably adjusting the curvature.

In the micro lens, the foundation member may have transmissivity.

According to the configuration, in the case of positioning the light emitting source on the side of the foundation member, the light from the light emitting source can be favorably emitted from the upper surface of the micro lens. Thus the condensing function can be exhibited by the curvature of the upper surface.

The optical device according to an aspect of the present invention is characterized in that a surface light emitting laser, and the micro lens obtained by the above-mentioned manufacturing method or the above-mentioned micro lens include, and the micro lens is positioned on, the emitting side of the surface light emitting laser.

According to the optical device, since the micro lens of which the size or the shape can be favorably controlled is positioned on the emitting side of the surface light emitting laser, the condensing of the emitted light from the light emitting laser can be favorably performed by the micro lens. Thus the excellent light emitting characteristics (the optical characteristics) can be obtained.

The optical transmission device according to an aspect of the present invention is characterized in that the above-mentioned optical device, a light receiving element, and an optical transmission device to transmit the light emitted from the optical device to the light receiving element are included.

According to the optical transmission device, since it includes the optical device having the excellent light emitting characteristics (the optical characteristics) as mentioned above, the optical transmission device having the excellent transmitting characteristics can be obtained.

The head for the laser printer according to an aspect of the present invention is characterized in that the above-mentioned optical device is included.

According to the head for the laser printer, since it includes the optical device having the excellent light emitting characteristics (the optical characteristics) as mentioned above, the head for the laser printer having the excellent drawing characteristics can be obtained.

The laser printer according to an aspect of the present invention is characterized in that the above-mentioned head for the laser printer is included.

According to the laser printer, since it includes the head for the laser printer having the excellent drawing characteristics as mentioned above, the laser printer having excellent drawing characteristics can be obtained.

### BRIEF DESCRIPTION OF THE DRAWINGS

FIGS. 1a to 1e show a process of manufacturing a micro lens according to an aspect of the present invention;

FIGS. 2a to 2c are schematics of an inkjet head;

FIGS. 3a and 3b show a process of manufacturing the micro lens according to an aspect of the present invention;

FIGS. 4a to 4c show the micro lens according to an aspect of the present invention;

FIGS. 5a to 5c show a condensing function of the micro lens;

FIG. 6 illustrates a contact angle of lens material according to a lyophobic processing; and

FIG. 7 is a schematic of a head for a laser printer according to an aspect of the present invention.

### DETAILED DESCRIPTION OF EXEMPLARY EMBODIMENTS

Hereinafter, the present invention will be explained in detail.

First, a method of manufacturing a micro lens according to an aspect of the present invention will be explained. The method of manufacturing the micro lens according to an aspect of the present invention includes forming a foundation member on a base, subjecting the upper surface of the foundation member to lyophobic processing; and ejecting lens material on the lyophobic-processed foundation member in a plurality of dots using at least two nozzles by a droplet ejecting head having a plurality of nozzles to form the micro lens on the foundation member.

Here, in the present invention, “base” refers to a substance having a surface on which the foundation member can be formed, and, in particular, refers to a glass substrate or a semiconductor substrate, or a material having various functional thin films or functional elements formed thereon. The surface on which the foundation member can be formed may be a curved surface or a flat surface. Specifically, the shape of the base is not specially limited, and may take various shapes.

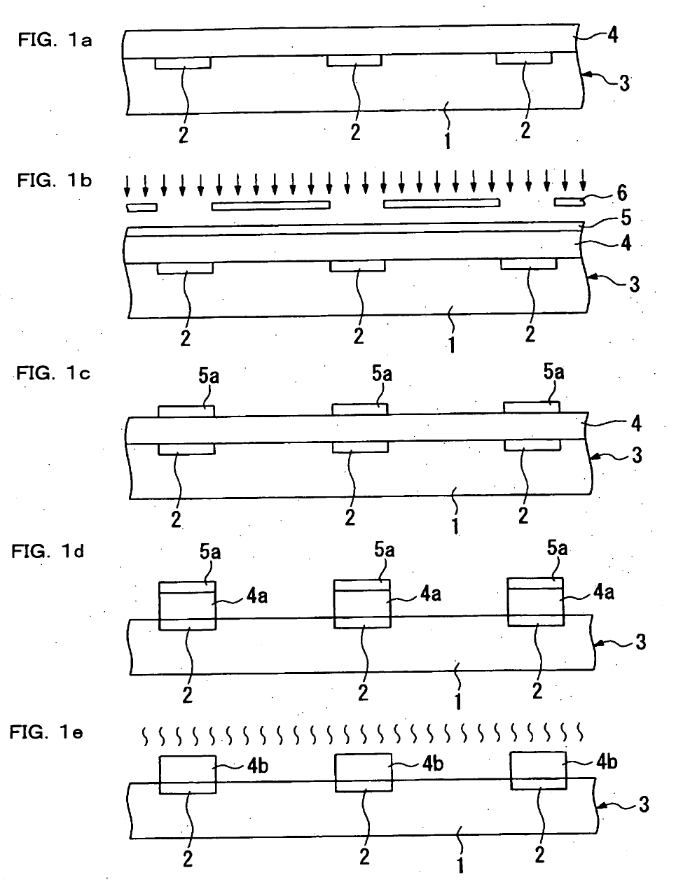

In an aspect of the present invention, as shown in FIG. 1a, for example, by using a GaAs substrate 1, the GaAs substrate 1 having a plurality of surface light emitting lasers 2 formed thereon is prepared as a base 3. The upper surface of the base 3, specifically, the surface of the emitting side of the surface light emitting lasers 2, is provided with a material to form the foundation member to form the foundation member material layer 4. The surface light emitting lasers 2 each have an insulating layer (not shown) composed of polyimide resin at the periphery of the emitting port thereof formed thereon. Here, as material to form the foundation member, material having transmissivity, specifically, material that hardly absorbs the wavelength region of the emitted light from the surface light emitting laser 2 but that substantially transmits the emitted light may be used. For example, although polyimide resin, acrylic resin, epoxy resin, or fluorine resin may be used, in particular, polyimide resin is preferable.

In the present exemplary embodiment, polyimide resin is used as the material to form the foundation member. A precursor of this polyimide resin is applied on the base 3. Then the base 3 is heated at a temperature of 150° C., thereby forming the foundation member material layer 4, as shown in FIG. 1a. The foundation member material layer 4 is not sufficiently cured so that it is just hard enough to maintain its shape.

When the foundation member material layer 4 composed of polyimide resin is formed, a resist layer 5 is formed on the foundation member material layer 4, as shown in FIG. 1b. A mask 6 having a predetermined pattern formed thereon is exposed by using the resist layer 5, and is developed, thereby forming a resist pattern 5a, as shown in FIG. 1c.

Next, by using the resist pattern 5a as the mask, the foundation member material layer 4 is patterned by a wet etching method using alkali solution. Thereby, as shown in FIG. 1d, the foundation member pattern 4a is formed on the base 3. Here, in the formed foundation member pattern 4a, the shape of the upper surface thereof may be circular, elliptical, or polygonal in order to form the micro lens thereon. In the present exemplary embodiment, the shape of the upper surface is circular. The foundation member material pattern is formed so that the central location of the circular upper surface is positioned immediately above the emitting port (not shown) of the surface light emitting laser 2 formed on the base 3.

Then, as shown in FIG. 1e, the resist pattern 5a is removed and heat treatment is performed at about 350° C. to sufficiently cure the foundation member pattern 4a, thereby forming the foundation member 4b.

Next, the upper surface of the foundation member 4b is subjected to lyophobic processing. As the lyophobic processing, for example, a plasma processing method (CF₄ plasma processing method) using tetrafluoromethane as the processing gas in air is suitably employed. The conditions of the CF₄ plasma processing are as follows: the plasma power is 50 to 1000 kW, the flow rate of tetrafluoromethane (CF₄) gas is 50 to 100 ml/min, the carrying rate of the base 3 with respect to the plasma discharge electrode is 0.5 to 1020 mm/sec, and the temperature of the base is 70 to 90° C.

The processing gas is not limited to tetrafluoromethane (CF₄) gas, and other fluorocarbon gas can be used. By performing the lyophobic processing, fluorine radicals are introduced into the resin on the upper surface of the foundation member 4b, thereby endowing it with high lyophobic properties.

Here, lyophobic processing may be performed so as to exhibit the lyophobic properties such that the contact angle of the lens material becomes 20° or more, when the below-mentioned lens material is positioned with respect to the plane formed of the material to form the foundation member 4b.

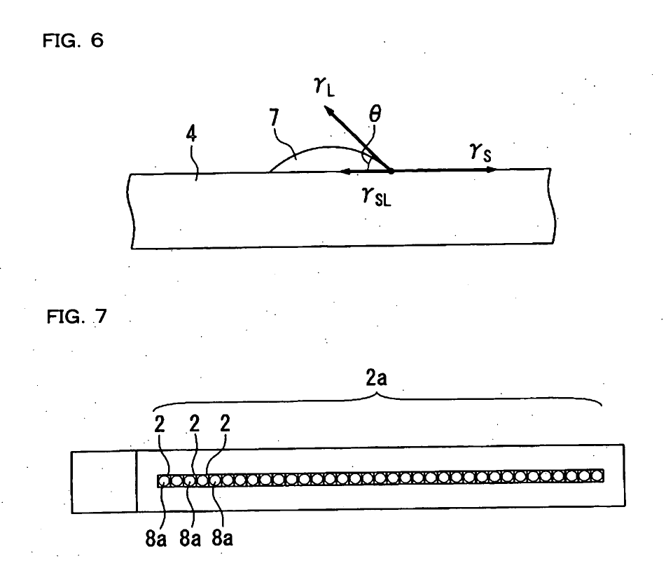

Specifically, as shown in FIG. 6, the foundation member material layer 4 is formed by the material to form the foundation member 4b (in this exemplary embodiment, polyimide resin), and the surface thereof becomes flat. The aforementioned lyophobic processing on this surface is performed. Next, the lens material 7 is positioned on this surface by the droplet ejecting method.

As a result, the lens material 7 forms droplets having a shape depending on the wettability with respect to the surface of the foundation member material layer 4. At this time, when the surface tension of the foundation member material layer 4 is γ_{S}, the surface tension of the lens material 7 is γ_{L}, the interface tension between the foundation member material layer 4 and the lens material 7 is γ_{SL}, and the contact angle of the lens material 7 with respect to the foundation member material layer 4 is θ, the following equation holds for γ_{S}, γ_{L}, γ_{SL}, and θ.

γ_{S}=γ_{SL}+γ_{L} ·cos θ

As mentioned below, the lens material 7 to form the micro lens has a curvature limited by the contact angle θ determined by the above-mentioned equation. The curvature of the lens that is obtained after curing the lens material 7 is one of the factors determining the shape of the final micro lens. Accordingly, in an aspect of the present invention, since the interface tension γ_{SL} between the foundation member material layer 4 and the lens material 7 is increased by the lyophobic processing so that the shape of the obtained micro lens becomes similar to a spherical shape, the contact angle θ may be large, that is, 20° or more.

Like this, the lyophobic processing according to the condition that the contact angle θ shown in FIG. 6 becomes 20° or more is performed on the upper surface of the foundation member 4b. Thus the contact angle θ′ of the lens material 7, which is ejected and positioned on the upper surface of the foundation member 4b, with respect to the upper surface of the foundation member 4b is increased as described later. Accordingly, the amount of lens material applied to the upper surface of the foundation member can be increased further. Then it is easy to control the shape thereof by the ejected amount (the ejected dot amount).

When the lyophobic processing on the upper surface of the foundation member 4b is performed, the lens material 7 is ejected onto the foundation member 4b in a plurality of dots by the droplet ejecting method. Here, as the droplet ejecting method, a dispenser method or an inkjet method can be employed. The dispenser method is a general method to eject the droplets, and is the method that is useful in ejecting the droplets over a relatively wide area. The inkjet method is a method to eject the droplet using an inkjet head. Since the inkjet method can control the location of ejecting the droplets to micrometer-order and can control the ejected amount of the droplets on the order of picoliters, this method may be used to manufacture minute lenses (micro lenses).

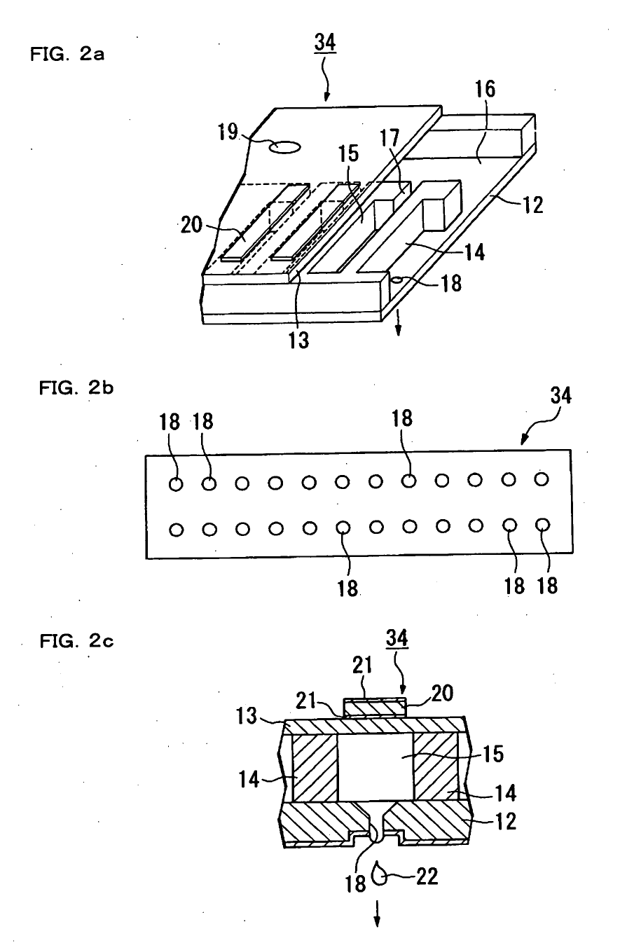

In the present exemplary embodiment, the inkjet method is used as the droplet ejecting method. The inkjet method uses, for example, an inkjet head 34 which has a stainless steel nozzle plate 12 and a vibration plate 13 adhered to each other by a partition member (the reservoir plate) 14, as shown in FIG. 2a. Between the nozzle plate 12 and the vibration plate 13, a plurality of cavities 15 . . . and a reservoir 16 are formed by the partition member 14. The cavities 15 . . . and the reservoir 16 are connected to each other through a flow path 17.

Each of the cavities 15 and the reservoir 16 are filled with liquid substance to be ejected (lens material). The flow path 17 therebetween functions as a supplying port to supply the liquid substance from the reservoir 16 to the cavity 15. The nozzle plate 12 has a plurality of hole-shaped nozzles 18 to eject the liquid substance from the cavity 15 formed thereon, which are arranged by two lines in the vertical direction and by 12 lines in the horizontal direction like the bottom surface of the inkjet head 34 shown in FIG. 2b. The vibration plate 13 has a hole 19 opened into the reservoir 16 formed thereon. The hole 19 is connected with the liquid substance tank (not shown) through a tube (not shown).

The surface facing the cavity 15 of the vibration plate 13 and the opposite surface thereof are adhered with a piezoelectric element 20, as shown in FIG. 2c. Since the piezoelectric element 20 is sandwiched between a pair of electrodes 21, 21 and is made to flex and protrude outward by supplying a current, it functions as the ejecting device in an aspect of the present invention.

Under this configuration, the vibration plate 13 adhered with the piezoelectric element 20 is integral with the piezoelectric element 20 and they are flexed outward, thereby increasing the capacity of the cavity 15. As a result, in the case where the cavity 15 is connected with the reservoir 16 and the reservoir 16 is filled with the liquid substance, the liquid substance corresponding to the increased capacity is introduced into the cavity 15 through the flow path 17 from the reservoir 16.

When the current supplied to the piezoelectric element 20 is stopped in this state, the piezoelectric element 20 and the vibration plate 13 return to their original shapes. Accordingly, since the cavity 15 also returns to its original capacity, the pressure of the liquid substance in the cavity 15 is increased and the droplets 22 of the liquid substance are ejected from the nozzles 18.

As the ejecting device of the inkjet head, a substance other than the electromechanical converting substance using the above-mentioned piezoelectric element 20 can be used. A method using an electro-thermal converting substance using an energy generating element, a subsequent method, such as charging control type or press vibration type, an electrostatic absorbing method, or a method to irradiate electromagnetic waves, such as laser light to generate heat and ejecting the liquid substance by the heating can be employed.

As the ejected lens material 7, that is, the lens material 7 that becomes the micro lens, a light-transmitting resin is used. Concretely, a thermosetting or thermoplastic resin, such as acrylic resin, such as polymethylmethacrylate, polyhydroxy-ethylmethacrylate, or polycyclohexylmethacrylate; aryl resin, such as polydiethyleneglycol-bisarylcarbonate, or polycarbonate; methacrylate resin; polyulethane resin; polyester resin; polyvinylchloride resin; polyvinylacetate resin; cellulose resin; polyamide resin; fluorine resin; polypropylene resin; polystyrene resin; or a combination thereof may be used.

In the present invention, as the light-transmitting resin, a non-solvent system may be used. The light-transmitting resin of the non-solvent system liquefies the light-transmitting resin by diluting it with a monomer, without dissolving and liquefying the light-transmitting resin by using an organic solvent, so as to eject the light-transmitting resin from the inkjet head 34. By mixing a photopolymerization initiator, such as biimidazole compound, the light-transmitting resin of the non-solvent system can be used as a radiation-curing type of resin. That is, by mixing the photopolymerization initiator, radiation hardening properties are supplied to the light-transmitting resin. Here, radiation is the general name for visible rays, ultraviolet rays, far-ultraviolet rays, x-rays, or electron beams, etc. and, in particular, ultraviolet rays are generally used.

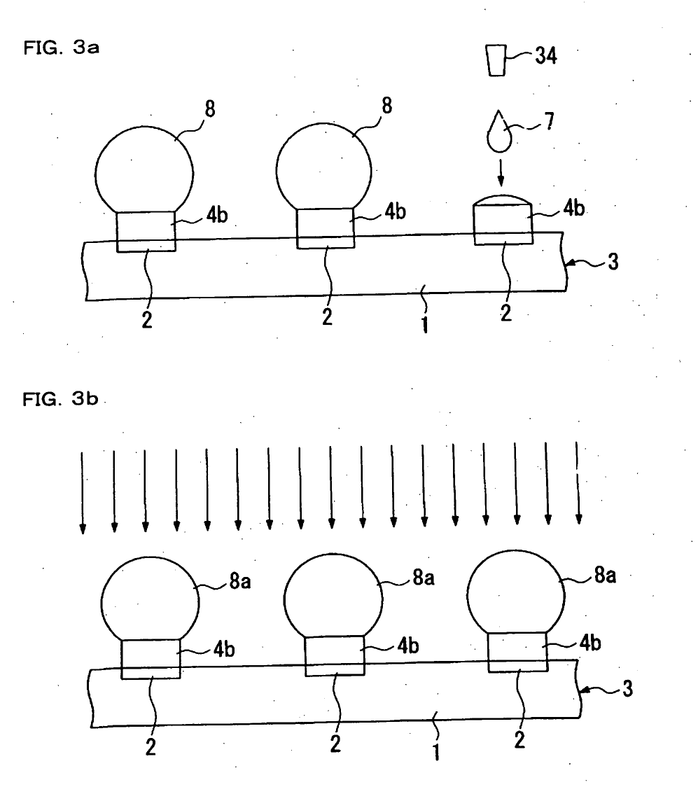

As shown in FIG. 3a, such lens material 7 is ejected on the foundation member 4b in a plurality of dots, for example, 10 to 30 dots, by the inkjet head 34 composed of the above-mentioned components, thereby forming the micro lens precursor 8 on the foundation member 4b. Here, the inkjet head 34 has a plurality of the nozzles 18 formed thereon so that the nozzles 18 are aligned in crosswise direction on the nozzle plate 12 as shown in FIG. 2b. But there is variance of the ejected amount between the nozzles 18, for example, due to the location difference therebetween.

Accordingly, in an aspect of the present invention, when ejecting the droplet of the ink material 7 from the inkjet head 34 in a plurality of dots, the lens material 7 in all the dots are not ejected from one nozzle 18. The lens material 7 is ejected on upper surface of one foundation member 5b using at least two nozzles 18.

For example, in case that the ink material 7 in ten dots is ejected on one foundation member 5b to form the micro lens precursor 8, as shown in FIG. 2b, the micro lens precursor 8 is formed by ejecting the material from one side of twelve nozzles 18 arranged in the horizontal direction among the nozzles 18 . . . by one dot in order and ejecting the material by ten nozzles 18 in total ten dots.

Among the nozzles 18 . . . arranged in the horizontal direction shown in FIG. 2b, by using two adjacent nozzles 18, the micro lens precursor 8 may be formed by ejecting the material in total ten dots. Specifically, ejecting the material alternately from the two nozzles 18 by one dot, in other words, ejecting the material from two nozzles 18 by five dots on one foundation member 5b.

These examples are a portion of the aspects of ejecting a plurality of the dots by using a plurality of nozzles 18, and various aspects may be employed.

Like this, since a plurality of the dots are ejected using at least two nozzles 18, although there is variance of the ejected amount between the nozzles 18, the influence of the variance of the ejected amount between the nozzles 18 can be reduced by forming one micro lens precursor 8 using at least two nozzles. If the material is ejected using a plurality of the nozzles 18 like an example using ten nozzles 18, the influence of the variance between the nozzles 18 can be more reduced.

Here, in the present exemplary embodiment, since the lens material 7 is ejected by the inkjet method, the lens material 7 can be precisely positioned in substantially the central portion on the foundation member 4b. As mentioned above, by subjecting the upper surface of the foundation member 4b to lyophobic processing, it is difficult for the droplets of the ejected lens material 7 to spread on the upper surface of the foundation member 4b. Accordingly, the lens material 7 positioned on the foundation member 4b is maintained on the foundation member 4b in a stable state, without dropping off the foundation member 4b. By intermittently ejecting lens material in several dots (in this example, 30 dots), the transverse section (the horizontal surface parallel with the upper surface of the foundation member 4b) of the micro lens precursor 8 composed of the ejected lens material 7 becomes larger than that of the upper surface of the foundation member 4b.

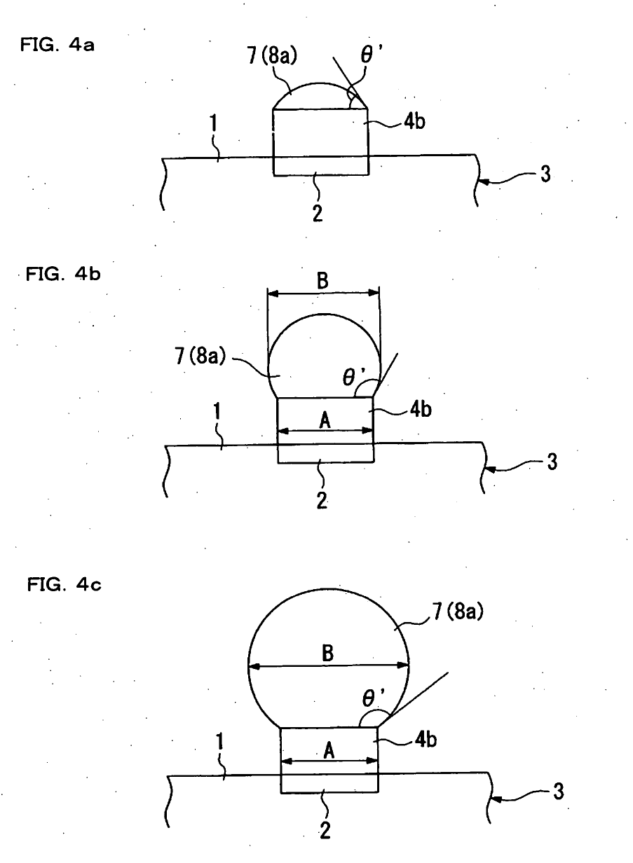

When initiating ejection of the lens material 7, since the amount of lens material 7 ejected is small, the amount of lens material is generally not increased to such an amount that the lens material is spread on the entire upper surface of the foundation member 4b. Thus the contact angle θ′ with respect to the upper surface of the foundation member 4b becomes an acute angle, as shown in FIG. 4a.

From this state, if the lens material 7 is continuously ejected, the lens material 7 ejected later has high adherence to the lens material 7 ejected previously. Thus the lens material is integral without being dropped off, as shown in FIG. 4b. The volume of the integral lens material 7 is increased, thereby increasing the contact angle θ′ with respect to the upper surface of the foundation member 4b to excess a right angle.

When the lens material 7 is continuously ejected in this state, the amount of lens material is not large in every dot because the lens material is ejected by the ink-jet method. Thus the overall balance on the foundation member 4b is maintained. At the result, the contact angle θ′ becomes a large obtuse angle, as shown in FIG. 4c, thus having a shape similar to a sphere.

Like this, by subjecting the upper surface of the foundation member 4b to lyophobic processing and positioning the lens material 7 in a plurality of dots by the ink-jet method (droplet ejecting method), which can precisely eject the lens material at the ejected location by a predetermined amount on the lyophobic-processed surface, the micro lens precursor 8 is made according to the desired shape until the contact angle θ′ is varied from a relatively small acute angle to a large obtuse angle. That is, the micro lens having a desired shape can be formed by determining the shape in advance in accordance with the shape of the micro lens formed of the ejected number of dots.

When forming the micro lens precursor 8 having the desired shape (a shape close to spherical, as shown in FIG. 4c in this exemplary embodiment), the micro lens precursor 8 is cured as shown in FIG. 3b, thereby forming the micro lens 8a.

In the curing process of the micro lens precursor 8, the substance subjected to radiation hardening without adding the organic solvent is provided as the lens material 7. Thus the processing method by irradiation of ultraviolet rays (wavelength λ=365 nm) may be used.

After the curing process by the irradiation of ultraviolet rays, heat treatment may be performed at about 100° C. for 1 hour. By performing the heat treatment, although hardening non-uniformity is generated in the curing process by irradiating ultraviolet rays, the hardening non-uniformity is decreased. Thus a substantially uniform hardness can be obtained as a whole.

Thereby, when forming the micro lens 8a, the base 3 is cut, if necessary, and the desired shape is made by forming the array shape or by performing separation.

An optical device of an exemplary embodiment of the present invention can be obtained from the micro lens 8a manufactured by the above-mentioned method and the surface light emitting laser 2 previously formed on the base 3.

In the method of manufacturing the micro lens 8a, since the micro lens 8a is formed on the foundation member 4b, the size or the shape of the obtained micro lens 8a can be suitably accomplished by suitably forming the size or the shape of the upper surface of the foundation member 4b. Further, since the upper surface of the foundation member 4b is lyophobic-processed, the contact angle θ′ of the ejected lens material 7 with respect to the surface of the foundation member 4b can become large, thereby increasing the amount of the lens material 7 applied to the upper surface of the foundation member 4b. In the state that the amount of the lens material 7 applied to the upper surface of the foundation member 4b is large, the lens material 7 is ejected in a plurality of dots. Thus the shape or the size of the obtained micro lens 8a can be controlled by suitably adjusting the number of the dots.

The shape of the micro lens 8a can become various shapes shown in FIGS. 4a to 4c. That is, a flat shape (FIG. 4a), a shape close to the semi-sphere in the side (FIG. 4b), and a shape close to a sphere in the side (FIG. 4c). Accordingly, in this exemplary embodiment, the emitted light from the surface light emitting laser 2 formed on the base 3 transmits the foundation member 4b to be emitted from the opposite side of the foundation member 4b. Specifically, the upper surface of the micro lens 8a, as shown in FIGS. 4a to 4c, the curvature of the upper surface of the micro lens 8a is suitably made. Thus the condensing function of the micro lens 8a is adjusted as set previously.

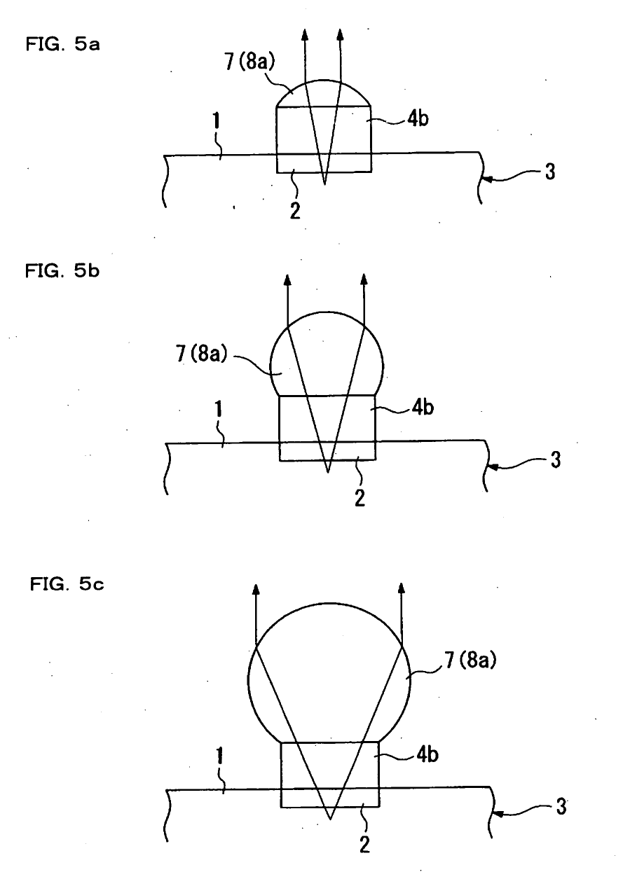

Accordingly, in case that the emitted light from the surface light emitting laser 2 transmits the foundation member 4b to be incident to the micro lens 8a as the irradiated light, the micro lens is formed so that the shape of the micro lens 8a. Specifically, the curvature of the upper surface of the micro lens 8a becomes a predetermined curvature in accordance with the irradiation degree of the irradiated light. Thus the irradiated light (the emitted light) from the surface light emitting laser 2 may be focused to the micro lens 8a, as shown in FIGS. 5a to 5c.

However, in case that the light from the light emitting source, such as the surface light emitting laser 2 has straightness without radiation, the light transmits the micro lens 8a, and then the transmitted light have radiation.

As mentioned above, since the material is ejected in a plurality of dots using at least two nozzles 18, even when there is variance of the ejected amount between the nozzles 18, the influence of the variance of the ejected amount between the nozzles 18 can be reduced by forming one micro lens precursor 8 using at least two nozzles. Accordingly, the non-uniformity of the shape of the obtained micro lens 8a is suppressed, the non-uniformity of the optical characteristics is suppressed and the micro lens 8a having excellent optical characteristics can be formed.

Particularly, as shown in FIGS. 4b and 4c, the micro lens 8a is formed so that the outer diameter B of the maximum transverse section among the transverse section parallel to the upper surface becomes large than the outer diameter A of the upper surface of the foundation member 4b. Thus the micro lens 8a is close to the sphere compared to that shown in FIG. 4a. Accordingly, the curvature of the upper surface can become relatively small, and the condensing function can be more increased.

In the optical device including the micro lens 8a manufactured as mentioned above and the surface light emitting laser 2 formed on the base 3, since the micro lens 8a, of which the size or the shape may be controlled as mentioned above and the non-uniformity is reduced or prevented, is positioned on the emitting side of the surface light emitting laser 2, the focus of the emitted light from the surface light emitting laser 2 may be performed by the micro lens 8a. Thus the good light emitting characteristics (the optical characteristics) can be obtained.

In the above-mentioned exemplary embodiment, the foundation member material layer 4 is formed on the base 3 to form the foundation member 4b from the foundation member material layer 4, but the present invention is not limited thereto. For example, in case that surface layer of the base 3 is formed of permeable material, the foundation member may be directly formed on the surface layer.

In the method of forming the foundation member 4b, it is not limited to the above-mentioned photolithography method. Another other method, for example, a selective growth method or a transferring method may be employed.

In the shape of the upper surface of the foundation member 4b, various shapes, such as a triangle or a quadrangle may be employed in accordance with the characteristics required for the micro lens to be formed. Further, in the shape of the foundation member 4b itself, various shapes, such as a taper or a reverse taper may be employed.

In the above-mentioned exemplary embodiment, the micro lens 8a formed on the foundation member 4b is used as the lens, but the present invention is not limited to this. The micro lens is stripped from the foundation member 4b by a suitable method, and the micro lens 8a alone may be used as the optical component. In this case, the foundation member 4b used in the manufacture needs not have transmissivity.

In an aspect of the present invention, in addition to the optical device having the surface light emitting laser 2 and the micro lens 8a, a light transmission device having an optical fiber or a optical waveguide to transmit the emitted light from the optical device and a light receiving device to receive the light transmitted by the optical transmission device are provided, it can function as the optical transmission device.

In such optical transmission device, since it has the optical device having superior light emitting characteristics (the optical characteristics) as mentioned above, the optical transmission device has superior transmitting characteristics.

The head for the laser printer according to an aspect of the present invention has the above-mentioned optical device. The optical device used in the head for the laser printer includes a surface light emitting laser array 2a that a plurality of surface light emitting lasers 2 are positioned straight and the micro lens 8a positioned on each of the surface light emitting lasers 2 forming the surface light emitting laser array 2a, as shown in FIG. 7. Further, a driving element (not shown), such as a TFT is provided in the surface light emitting laser 2, and a temperature compensating circuit (not shown) is provided in the head for the laser printer.

Further, the laser printer according to an aspect of the present invention can be manufactured by equipping the head for the laser printer having the above-mentioned structure.

Since the head for the laser printer is equipped with the optical device having superior light emitting characteristics (the optical characteristics) as mentioned above, the head for the laser printer having superior drawing characteristics can be obtained.

Since the laser printer having this head for the laser printer is equipped with the head for the laser printer having superior drawing characteristics, the laser printer has excellent drawing characteristics.

The micro lens according to an aspect of the present invention can be applied to various optical devices other than the above-mentioned optical device, and, for example, the optical component provided in a light receiving surface of a charge coupled device (CCD) or a light coupling portion of the optical fiber can be used.

What is claimed is:

1. A method of manufacturing a micro lens, comprising:
forming a foundation member on a base;
subjecting an upper surface of the foundation member to lyophobic processing; and
ejecting lens material on the lyophobic-processed foundation member in a plurality of dots using at least two nozzles by a droplet ejecting head having a plurality of nozzles to form the micro lens on the foundation member.

2. The method of manufacturing a micro lens according to claim 1,
the lyophobic processing including, when the lens material is positioned with respect to a plane formed of the foundation member forming material, performing the lyophobic process so that lyophobic properties that cause the contact angle of the lens material to be 20° or more, are exhibited.

3. The method of manufacturing a micro lens according to claim 1,
the forming including forming the foundation member, such that a shape of the upper surface of the foundation member is circular, elliptical, or polygonal.

4. The method of manufacturing a micro lens according to claim 1,
when ejecting the lens material by the droplet ejecting method, the number of the ejected dots being determined so that a curvature of the upper surface of the formed micro lens becomes a predetermined curvature.

5. The method of manufacturing a micro lens according to claim 1,
the lens material composed of a non-solvent-type light-transmitting resin.

6. A micro lens formed according to the method of claim 1.

7. The micro lens according to claim 6,
a shape of the upper surface of the foundation member being circular, elliptical, or polygonal.

8. The micro lens according to claim 6,
a maximum outer diameter of a transverse section of the micro lens parallel to the upper surface of the foundation member being larger than an outer diameter of the upper surface of the foundation member.

9. The micro lens according to claim 6,
the foundation member having transmissivity.

10. An optical device, comprising:
a surface light emitting laser; and
a micro lens obtained by the manufacturing method according to claim 1,
the micro lens positioned on the emitting side of the surface light emitting laser.

11. An optical transmission device, comprising:
an optical device according to claim 10, a light receiving element, and an optical transmission device to transmit light emitted from the optical device to the light receiving element.

12. A head for a laser printer, comprising:
the optical device according to claim 10.

13. A laser printer, comprising:
the head for a laser printer according to claim 12.

14. An optical device, comprising:
a surface light emitting laser; and
the micro lens according to claim 6, the micro lens positioned on the emitting side of the surface emitting laser.
